(19) United States
(12) Patent Application Publication
(10) Pub. No.: US 2005/0243182 A1
(43) Pub. Date: Nov. 3, 2005

(54) METHOD FOR SAMPLING IMAGE SIGNAL AND IMAGE SENSING APPARATUS THEREFOR

(76) Inventors: David Shiung, Tainan City (TW); Yung-Lung Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,672

(22) Filed: Sep. 30, 2004

(30) Foreign Application Priority Data
Apr. 29, 2004 (TW) 93111983

(51) Int. Cl. H04N 5/228

(52) U.S. Cl. 348/222.1

(57) ABSTRACT

A method for sampling an image signal and an image sensing apparatus therefor are provided. In the apparatus and method, image sensor cells in the image cell array are divided into a plurality of image cell groups before sampling. Since an image to be sampled is divided into a plurality of portions, the present invention does not require buffers with high capacity for image processing after sampling, or memories with high capacity for storing sampled images. Therefore, a cost for image sampling is significantly reduced. In addition, by dividing the image to be sampled into a plurality of portions, it is not necessary to divide the sampled image during image processing, which also significantly reduces the time for image processing and improves the performance and efficiency thereof.

### CROSS-REFERENCE TO RELATED APPLICATION

This application claims the priority benefit of Taiwan application serial no. 93111983, filed on Apr. 29, 2004.

### BACKGROUND OF THE INVENTION

1. Field of Invention

The present invention generally relates to a method for sampling an image signal and an image sensing apparatus therefor, and more particularly, to a method for sampling an image signal and an image sensing apparatus therefor, in which a plurality of image sensor cells are divided into several image sensor groups, wherein an image signal is generated from each of these image sensor groups sequentially.

2. Description of Related Art

A conventional digital camera uses image sensor units such as charge coupled devices (CCD) for sensing image signals from an object. These image sensor units include a plurality of two-dimensional arrays, called image cell arrays, consisting of a plurality of image sensor cells. Each of the image sensor cells in the image cell arrays senses the image corresponding to its position and transfers the sensed image into electrical signals for subsequent image processing.

Refer to FIG. 1, which shows a conventional method for sampling an image signal in an image cell array. In FIG. 1, an image cell array 10 includes a plurality of image sensor cells 11, arranged in an array order. The conventional method for sampling image signals can be implemented in several ways, including:

(1) sampling the image signals from the image sensor cells in the image cell array 10 cell-by-cell and row-by-row, starting from cell 11, as shown in FIG. 1; or

(2) sampling the image signals from the image sensor cells in the image cell array 10 cell-by-cell and column-by-column, starting from cell 11; or

(3) sampling the image signals from the image sensor cells in the image cell array 10 cell-by-cell in every odd row/column and then cell-by-cell in every even row/column, starting from cell 11.

After the image signals are sampled and obtained, the next process is usually image processing. During image processing, the sampled image signals are divided into several image regions because the capacity allowed in the processing step is dependent on the designed specification. Therefore, when a digital camera samples image signals using one of these conventional ways, a buffer or a memory with high capacity is required, in order to save these sampled image signals first, and then divide the sampled image signals saved in the buffer or memory into several image regions, since the capacity in the image processing procedure is limited. As a result, the image processing becomes very slow and therefore the time required is very long. The buffers or memories with high capacity required in the digital camera also significantly increase the cost of production.

### SUMMARY OF THE INVENTION

Therefore, the present invention is directed to a method for sampling an image signal, wherein after image sensor cells obtain a plurality of sampled image signals, an image processing procedure can be performed without time delay.

The present invention is also directed to an apparatus for sensing an image, wherein buffers or memories with high capacity for storing the whole sampled signals are not required for image processing, and therefore the cost for the apparatus is significantly reduced.

In one embodiment of the invention, a method for sampling an image signal is provided, which is capable of sampling a plurality of image sensor cells in the image sampling process. In the embodiment, a plurality of image sensor cells are divided into a plurality of image cell groups. Then an image sampling process is sequentially performed on the image sensor cells in each of the image cell groups.

In one embodiment of the invention, an apparatus comprising a plurality of image sensor cells divided and grouped into a plurality of image cell groups is provided. Each of the image cell groups comprises a portion of said image sensor cells, wherein an image sampling process is performed on all of the image cell groups as sampling units and image signals are sampled and generated therefrom.

In the method and apparatus above, the image sampling process performed on the image cell groups is determined by an image processing specification thereafter. In one embodiment, the number of the image sensor cells in each of the image cell groups is the same. In another embodiment, the number of the image sensor cells in each of the image cell groups is different from each other.

In the method and apparatus above, all of the image sensor cells are arranged in an array order, called image cell array.

In one embodiment, the image sensor cells in the image cell array are arranged in a plurality of rows, and the image sampling process is sequentially performed on the image cell groups row-by-row. In another embodiment, the image sensor cells in the image cell array are arranged in a plurality of columns, and the image sampling process is sequentially performed on the image cell groups column-by- column. In still another embodiment, the image sensor cells in each of the image cell groups in the image cell array sequentially performs the image sampling process in a zigzag manner. In yet another embodiment, the image sensor cells in each of the image cell groups are arranged in a plurality of rows in a radial order in the image cell array.

In the method and apparatus above, each of the image sensor cells comprises a plurality of color sensor units, the color sensor units being used to sense red, green and blue lights, respectively. In another embodiment, each of the image sensor cells comprises one color sensor unit, the color sensor unit being used to sense one of the red, green and blue lights, respectively.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 shows a conventional method for sampling image signals in an image cell array.

FIG. 2A shows a block diagram of an apparatus for sensing an image according to one embodiment of the present invention.

FIG. 2B shows a diagram of an arrangement of an image cell array according to one embodiment of the present invention.

FIG. 2C shows a diagram of another arrangement of an image cell array according to one embodiment of the present invention.

FIG. 3 shows a flow chart of a method for sampling image signals on the image cell array according to another embodiment of the present invention.

FIGS. 4A and 4B show the flowcharts of a method for sampling image signals on the image cell array according to yet another embodiment of the present invention.

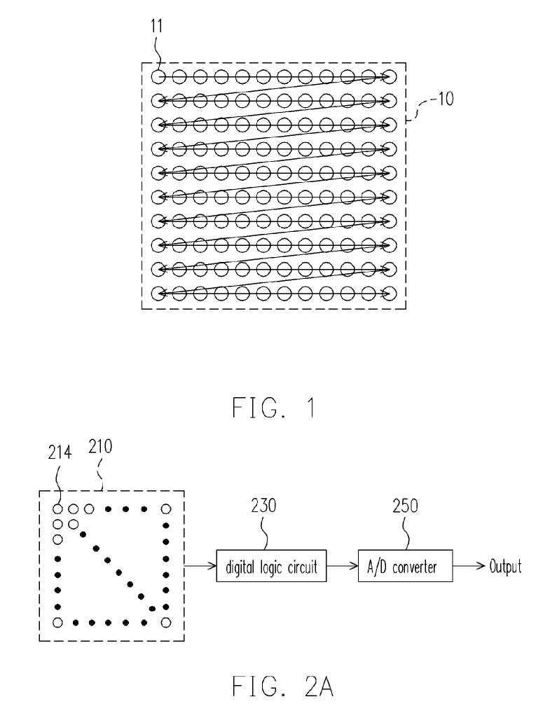

### DESCRIPTION OF THE EMBODIMENTS

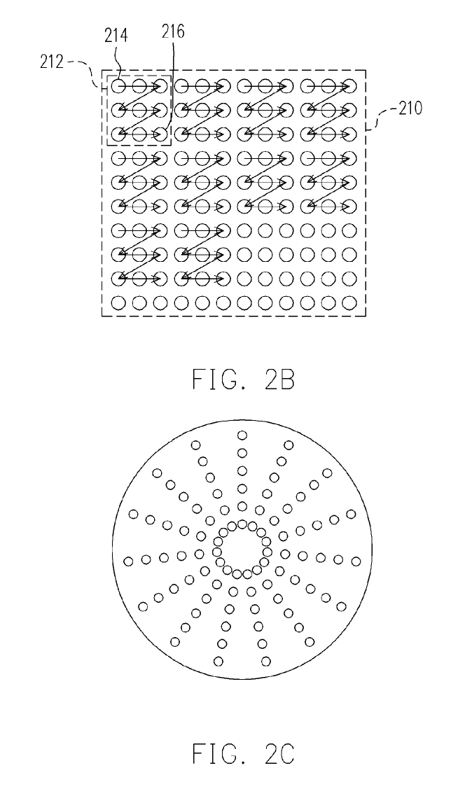

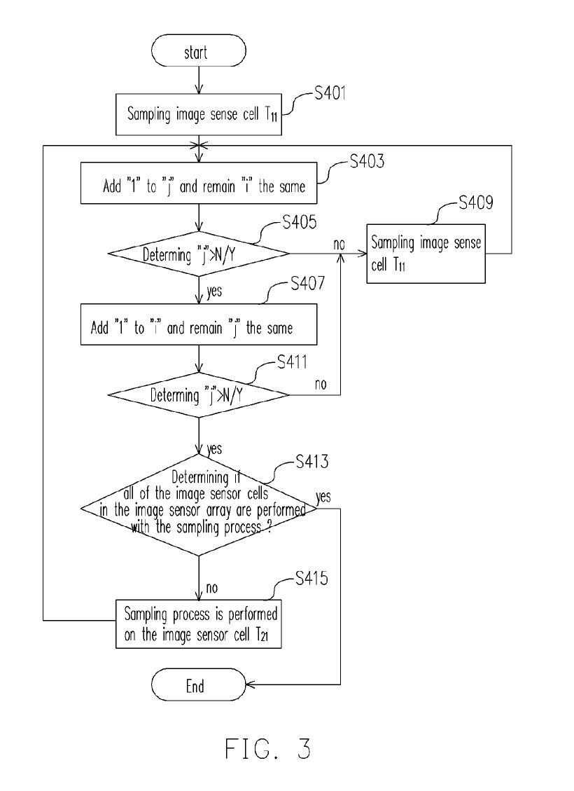

Please refer to FIG. 2A, which shows a block diagram of an apparatus for sensing an image according to one embodiment of the present invention. The apparatus (for example, a CMOS sensor device or a CCD sensor device) includes an image cell array 210, a logic circuit 230 and an analog-to-digital converter (A/D converter) 250. The image cell array 210 includes a plurality of image sensor cells 214, which comprises, for example but not limit to, a first color sensor unit, a second color sensor unit, and a third color sensor unit. These color sensor units can be, for example, red, green and blue sensor units, respectively. In another embodiment, the image sensor cell 214 can also be a single color sensor unit; for example, an image sensor unit for one of the red, green or blue color sensor units. The outputs of these image sensor cells 214 are all coupled to the logic circuit 230, which transfers the signal to the A/D converter 250. The A/D converter 250 converts analog signals from the logic circuit 230 into digital signals, and then outputs these converted digital signals to an output terminal of the A/D converter 250.

Refer to FIG. 2B, which shows a diagram of an image cell array in one embodiment of the present invention. The image cell array 210 includes a plurality of image sensor cells arranged in an array order. In one embodiment of the present invention, the image sensor cells in the image cell array 210 are divided into a plurality of image cell groups. As shown in FIG. 2B, the image cell array 210 includes a plurality of image cell sub-arrays 212. The image cell sub-arrays 212 comprise several image sensor cells including image sensor cells 214 and 216. An order of these image sensor cells in the image cell sub-arrays 212 sensing images can be arranged in a zigzag manner as shown in FIG. 2B. That is, the image sensing order can start from the image sensor cell 214 and ends with the image sensor cell 216. The image cell sub-array 212 is a basic unit for sampling image signals in this embodiment of the present invention.

The invention is not limited to the image cell sub-arrays shown in FIG. 2B. The number of the image cell sub-arrays in the image cell array can be determined in accordance with an image processing specification to meet the requirement for sampling image signals. One of ordinary skill in the art can determine the number of image sensor cells in the image cell sub-arrays to meet the capacity requirement of processing sampled image signals during image processing.

The image cell sub-arrays in the image cell array can be arranged in accordance with the requirement of different image processing procedures. For example, in another embodiment in FIG. 2C, a diagram of an image cell array of the present invention is shown. The image cell array includes a plurality of image sensor cells arranged in a plurality of rows in a radial order. In the embodiment of the present invention, the image sensor cells in the image cell array are divided into a plurality of image cell groups by, for example, each row. As shown in FIG. 2C, the image cell array includes a plurality of image cell sub-arrays, each of which includes a plurality of image sensor cells in each row. The image cell sub-array is a basic unit for sampling image signals in the present invention.

The invention is not limited to the image cell sub-arrays shown in FIG. 2C. The number of the image cell sub-arrays in the image cell array can be determined in accordance with an image processing specification. In order to meet the requirement for processing the sampled image signals, one of ordinary skill in the art can determine the number of image sensor cells in the image cell sub-arrays to meet the capacity requirement of processing sampled image signals during image processing.

Referring to FIG. 2B, the image cell sub-array 212 including 3×3 image sensor cells in the image cell array 210 is used as an exemplary arrangement for the present invention. During a process of sampling image signals from the image cell array 210, the image cell sub-array 212 is used to sample the image signal first, wherein the nine image sensor cells from 214 to 216 perform the process sequentially, as shown in FIG. 2B. The order of sampling the image signals shown in FIG. 2B is an exemplary arrangement, and the present invention is not limited to such a specific arrangement.

An order to perform sampling image signals on the image cell sub-arrays is not restricted to the aforesaid zigzag manner, but can also be determined in accordance with an image processing specification. The determination depends on the requirement of the sampled image signals. An embodiment of a flowchart of sampling the image signals from the image cell sub-arrays of the image cell array 210 is shown in FIG. 3. However, the method in FIG. 3 is not used to limit the present invention thereto. In the following description, the number of the row or column in each image cell array (sub-array) is the number of the image sensor cells in each row or in each column, and details will not be repeated.

First Embodiment

Please refer to FIG. 2B. The order of sampling the image signals on the image cell array 210 is array-by-array for all the image cell sub-arrays and row-by-row or column-by-column in each image cell sub-array.

Second Embodiment

The method of sampling image signals on the image cell array 210 starts from odd image cell sub-arrays are then even image cell sub-arrays sequentially. In each of the image cell sub-arrays, the order of sampling the image signals can be row-by-row or column-by-column, as desired.

For clearly describing the embodiments, it is assumed that the image sensor array 210 is an array with M×N elements, wherein M and N are positive integers, which respectively represents the rows and columns of the image sensor array 210. In addition, it is also assumed that Tᵢⱼ represents an image sensor cell in the I^{th} row and the j^{th} column arranged in the image sensor array 210. It is also assumed that the image sub-array is an array with X×Y elements, wherein X and Y are positive integers and X is smaller than the M and Y is smaller than N. X and Y respectively represent numbers of the rows and columns of the image sensor array 210.

For more details, please refer to FIGS. 2B and 3. In step S401, a sampling process is first performed on an image sensor cell T₁₁, which represents an image sensor cell in the first row and the first column in the image sensor array 210. In step S403, the value of “j” corresponding to image sensor cell T₁₁ is added with “1” and the value of “i” remains the same; that is, the image sensor cell T₁₂ is next. In step S405, it is then determined if the value of “j” is greater than N/Y. If not, a further sampling process is performed on another image sensor cell T₁₂ in step S409 and then the process goes back to step S403. If the value of “j” is greater than N/Y, as in step S407, “i” is added with “1” and the value of “j” is reset to “1.”

In step S411, it is determined if the value of “i”is greater than M/X. If the value of “i” is smaller than or equal to M/X, a sampling process is performed on image sensor cell in step S409. If the value of “i” is greater than M/X, it is then determined if all of the image sensor cells in the image sensor array are performed with the sampling process, as in step S413. If not, a sampling process is performed on the image sensor cell T21 in step S415 and the process goes back to step S403. If all of the image sensor cells in the image sensor array are performed with the sampling process, the sampling process in the image sensor array stops.

Third Embodiment

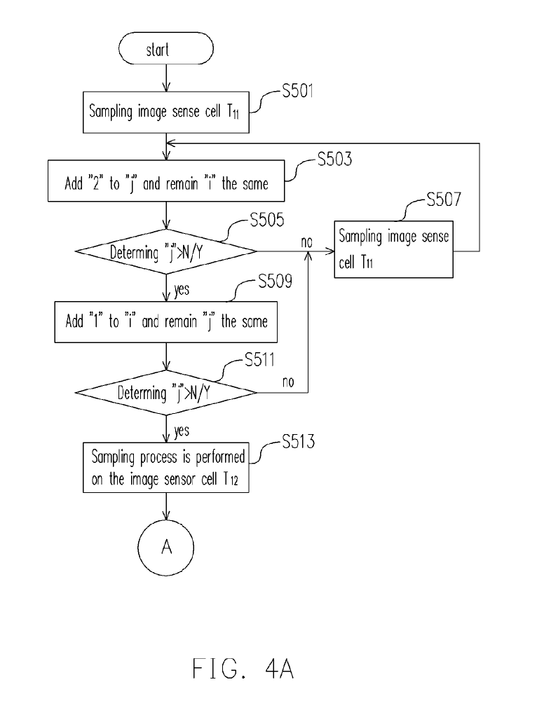

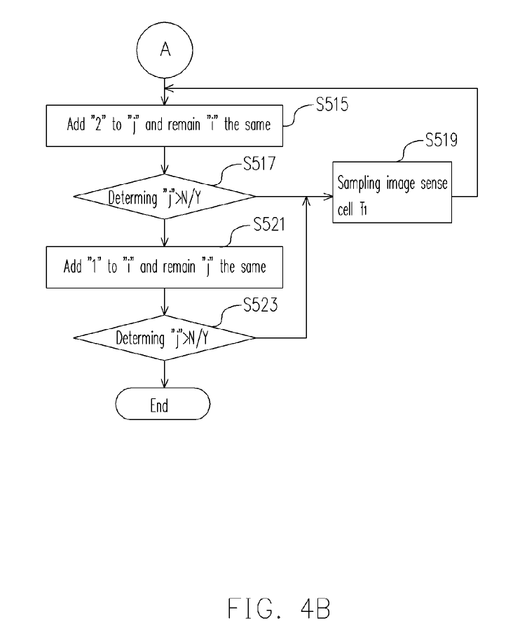

The third embodiment of a method for sampling image signals on the image cell array is shown in FIGS. 4A and 4B. With reference to FIG. 2B along with FIGS. 4A and 4B, in the embodiment, an image cell sub-array which starts a sampling process is marked as the first image cell sub-array. The next image cell sub-array performing the sampling process is marked as the second image cell sub-array. All of the image cell sub-arrays in the image cell array are marked with sequential numbers. According to the marked numbers, the image cell sub-arrays with odd numbers perform the sampling process first, followed by the image cell sub-arrays with even numbers.

For more details, a sampling process in the embodiment is shown in FIGS. 4A and 4B. In step S501, a sampling process is first performed on an image sensor cell T₁₁, which represents an image sensor cell in the first row and the first column in the image sensor array 210. In step S503, the value of “j” corresponding to image sensor cell T₁₁ is added with “2” and the value of “i” remains the same; that is, the image sensor cell T₁₃ is next. In step S505, it is then determined if the value of “j” is greater than N/Y. If not, a further sampling process is performed on another image sensor cell Tᵢⱼ in step S507 and then the process goes back to step S503. If the value of “j” is greater than N/Y, as in step S509, “i” is added with “1” and the value of “j” is reset to “1.” In step S511, it is then determined if the value of “i” is greater than M/X. If the value of “i” is smaller than or equal to M/X, a sampling process is performed on image sensor cell in step S507. If the value of “i” is greater than M/X, a sampling process is performed on another image sensor cell T₁₂ in step S513.

Please refer to FIG. 4B. In step S515, the value of “j” corresponding to image sensor cell T₁₂ is added with “2” and the value of “i” remains the same; that is, the image sensor cell T₁₄ is next. In step S517, it is then determined if the value of “j” is greater than N/Y. If not, a further sampling process is performed on another image sensor cell Tᵢⱼ in step S519 and then the process goes back to step S515. If the value of “j” is greater than N/Y, as in step S521, “i” is added with “1” and the value of “j” is reset to “2.” In step S523, it is then determined if the value of “i” is greater than M/X. If the value of “i” is smaller than or equal to M/X, a sampling process is performed on image sensor cell Tᵢⱼ in step S519. If the value of “i” is greater than M/X, the sampling process in the image sensor array stops.

In summary, there are at least the following advantages in the present invention. First, the image sensor cells in the image cell array are grouped and divided into a plurality of image cell groups prior to image sampling. That means the image to be sampled is divided into a plurality of portions, which does not require buffers with high capacity for image processing after sampling, or memories with high capacity for storing sampled images. Therefore, the cost of the image sampling process is significantly reduced. In addition, by dividing the image to be sampled into a plurality of portions in the beginning, it is not necessary to divide the sampled image during image processing, which also significantly reduces the time for image processing and improves the performance and efficiency thereof.

In addition, the image sampling process in the present invention is performed on all of the image sensor cells in each of the image cell groups, so the average exhaustion speed of charges stored in the image sensor cells does not change, which further ensures the quality of the sampled image.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for sampling an image signal, comprising:
dividing a plurality of image sensor cells into a plurality of image cell groups, each of the image cell groups comprising a portion of the said image sensor cells;
sequentially performing an image sampling process on the image sensor cells in each of the image cell groups.

2. The method as claimed in claim 1, wherein the image sampling process performed on the image cell groups is determined by an image processing specification thereafter.

3. The method as claimed in claim 1, wherein a number of the image sensor cells in each of the image cell groups is the same.

4. The method as claimed in claim 1, wherein a number of the image sensor cells in each of the image cell groups is different from each other.

5. The method as claimed in claim 1, wherein all of the image sensor cells are arranged in an array order, called image cell array.

6. The method as claimed in claim 5, wherein the image sensor cells in the image cell array are arranged in a plurality of rows, and the image cell groups perform the image sampling process row-by-row sequentially.

7. The method as claimed in claim 5, wherein the image sensor cells in the image cell array are arranged in a plurality of columns, and the image cell groups perform the image sampling process column-by-column sequentially.

8. The method as claimed in claim 5, wherein the image sensor cells in each of the image cell groups in the image cell array perform the image sampling process in a zigzag manner sequentially.

9. The method as claimed in claim 5, wherein the image sensor cells in each of the image cell groups are arranged in a plurality of rows in a radial order in the image cell array.

10. A apparatus for sensing an image, the apparatus comprising a plurality of image sensor cells being divided and grouped into a plurality of image cell groups, each of the image cell groups comprising a portion of said image sensor cells, wherein an image sampling process is performed on all of the image cell groups as sampling units and image signals are sampled and generated therefrom.

11. The apparatus as claimed in claim 10, wherein the image sampling process performed on the image cell groups is determined by an image processing specification thereafter.

12. The apparatus as claimed in claim 10, wherein a number of the image sensor cells in each of the image cell groups is the same.

13. The apparatus as claimed in claim 10, wherein a number of the image sensor cells in each of the image cell groups is different from each other.

14. The apparatus as claimed in claim 10, wherein all of the image sensor cells are arranged in an array order, called image cell array.

15. The apparatus as claimed in claim 14, wherein the image sensor cells in the image cell array are arranged in a plurality of rows, and the image cell groups perform the image sampling process row-by-row sequentially.

16. The apparatus as claimed in claim 14, wherein the image sensor cells in the image cell array are arranged in a plurality of columns, and the image cell groups perform the image sampling process column-by-column sequentially.

17. The apparatus as claimed in claim 14, wherein the image sensor cells in each of the image cell groups in the image cell array perform the image sampling process in a zigzag manner sequentially.

18. The apparatus as claimed in claim 14, wherein the image sensor cells in each of the image cell groups are arranged in a plurality of rows in a radial order in the image cell array.

19. The apparatus as claimed in claim 10, wherein each of the image sensor cells comprising a plurality of color sensor units, the color sensor units being used to sense red, green and blue lights, respectively.

20. The apparatus as claimed in claim 10, wherein each of the image sensor cells comprises a color sensor unit, the color sensor unit being used to sense one of the red, green and blue lights, respectively.
